(19) United States
(12) Patent Application Publication
(10) Pub. No.: US 2004/0107864 A1
(43) Pub. Date: Jun. 10, 2004

(54) Lane power

(76) Inventor: Joseph W. Hayden, Old Lyme, CT (US)

Correspondence Address: JOSEPH W. HAYOEN, 301 BRIGHT WATER RD, OLD LYME, CT, 06371, US

(21) Appl. No.: 10/233,350

(22) Filed: Dec. 9, 2002

(51) Int. Cl. B60L 1/00

(52) U.S. Cl. 104/288

(57) ABSTRACT

The nature of this invention called “Lane Power” is the electrical power source for the hobby of slot cars.

What is new in this hobby is the introduction of adjustable regulated direct current power supply over existing fixed direct current power supply.

Name of Invention? Lane Power

Who would buy your invention? New Generation and Veterans Model Racing Car (Slot Car) Enthusiasts.

How is it used? A power pack supply system upgrade that feeds each lane separately with its own power supply will meet the requirements of virtually any kind of model car (slot car) a hobbyist is likely to run on a commercial or home set.

Describe your invention: The redevelopment of power distribution for slot cars is as follows:

Each lane has its own adjustable regulated DC power supply along with its own adjustable ohms rheostat controller. The purpose of the regulated DC power supply is to allow the slot car to run on its own for model railroading purposes or switch to the adjustable ohms rheostat controller for racing purposes. The purpose for each lane to have its own adjustable regulated DC power supply is so that the slot car is independent of the other slot car, allowing for voltage regulation of the slot car's motor. This way vintage slot cars can run with modern day slot cars. Existing power distribution for slot cars comes with only one fixed DC power supply for all lanes.

Plenty of Power

Each lane needs a separate electrical power supply circuit. If there is only one power supply connection, the controller on one lane can affect the controller on another lane. For example, if you are power-sliding your car around a turn at the edge of control and your competitor suddenly goes from full throttle to none to enter a corner, your lane will receive a surge of power that will send your car flying. The Scalextric, SCX, Tomy, Mattel, and Life-Like sets have a power pack that is shared by both lanes.

I strongly recommend you purchase a second connector or terminal track for your Scalextric or SCX track, and a second Scalextric or SCX power pack with about 13-volt amps per lane. I suggest the Scalextric C8066 Power Plus connector tracks. Decide which power pack is to be dedicated to which lane, and cover the controller connection with tape or a black plug so two controllers cannot be connected to the same lane. Ninco, Carrera, and Artin have single power packs, but the circuits inside the pack are divided so each lane has its own power. You may find that the Artin power pack's 0.15 amps per lane is not enough current. The Carrera Exclusiv power pack comes with the 1/32-scale sets and offers 14 volts with 0.24 amps per lane, and Ninco also offers power packs with more amps to replace the weaker Artin pack.

Experienced model car racers purchase a filtered pure 13 volts of DC power from a $40 transformer, such as Radio Shack's 220-503, for each lane. Personally, I can't tell much difference between Carrera's optional No. 20731 Exclusiv power pack with 18 volts and 0.6 amps per lane and the Radio Shack transformers with 13 volts and 3.0 amps per lane, but I probably could notice a difference if I were racing modified cars with faster motors and stronger magnets.

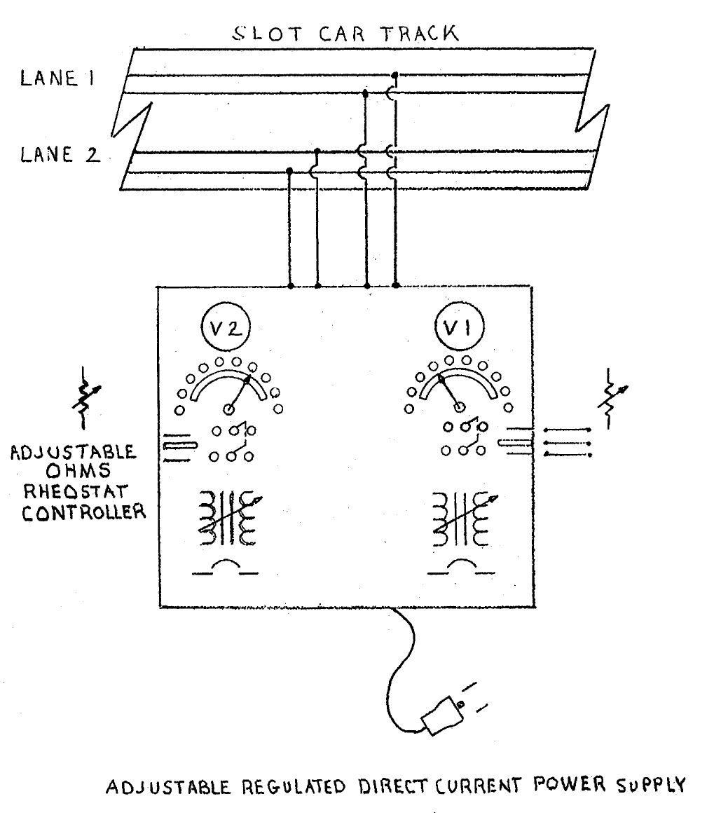

All power supplies have a transformer to convert 110 volt current to a lower throttle voltage. This is connected to a rectifier that converts household alternating current (AC) to direct current (DC). FIG. 1 shows the output voltage wave form from the rectifier on an oscilloscope. At the bottoms of the dips, the voltage is zero. The tops of the bumps are at 24 volts. Thus the current from the rectifier comes out in short spurts 120 times per second. Some power supplies connect the rectifier voltage directly to the throttle (which is effectively a variable resistor), then to the output. For our purposes, this output is called “unfiltered” DC.

Most manufacturers want to make the power-supply output voltage look more like that from a battery, in which the current is constant (FIG. 2). Because the constant-voltage line on the oscilloscope is flat, or linear, a constant DC voltage is sometimes called “flat” or “linear” DC. To obtain a more constant DC voltage, a capacitor is attached to the output of the rectifier. This acts as a reservoir for charge to provide current to the throttle and output when the voltage input from the rectifier is low. Also, a large, low-valued resistor is placed at the output of the capacitor to limit the current somewhat in case of a short circuit in the output. In this article, we refer to the constant-voltage output as “filtered” DC, where the capacitor and resistor make up the “filter.”

As indicated before, the throttle portion of the power supply is effectively a variable resistor in series with the output to the track. If the throttle resistance is large compared to that of the locomotive motor, most of the voltage drop from the filtered or unfiltered DC source appears across this resistor and not across the motor, which is then stopped. If the resistance is low when compared to the motor, most of the voltage drop will appear across the motor, which is then running like crazy. In either case, the drop across the throttle resistance causes heat that must be dissipated one way or the other. To eliminate this heat problem, some manufacturers have gone to what is called “pulse-width modulation,” or PWM, to control the speed of the motor. In this case, full-filtered DC power is sent to the motor for some portion of a cycle in the form of a pulse (like a pulsed shower nozzle). As the pulse makes up a greater portion of the cycle, more current is sent to the motor over the cycle and it runs faster (FIG. 3). Thus, the throttle is simply an opening and closing switch that generates very little heat.

Which Controller?

Every racing set includes a controller for each lane. Most controllers are shaped like a pistol and the speed is controlled with your trigger finger. Pistol-grip controllers are offered by Scalextric, SCX, Ninco, Artin, Tomy, Mattel, and Parma, to name a few. Some model car racers prefer the plunger-type controller, in which the controller is held like baseball bat and the throttle controlled with your thumb. Plunger-style controls are standard from Carrera and MRRC.

The controllers are rated in ohms and are matched to the cars in the set. You may find that you have more control of cars with powerful motors such as the Fly cars if you use a controller with a lower ohm rating. You may also want to try a different controller because you like the feel better. If you want a controller with a lower-than-standard ohm rating of, say, 30 or 45, Ninco's Vario and Carrera's Xtreme-Control controllers have adjustable ohm ratings so one controller can be used for any brand of car. Scalextric offers a 30-ohm controller, and Parma and MRRC offer controllers with 45, 25 and less ohms. Scalextric offers a C8052 Power & Control package for powerful cars that includes two 30-ohm controllers and their Power Base connector track with brake, reversing switch, and a second transformer.

If you want to try a controller that is a different brand from the track, you will usually have to make an adapter to connect the controller to the track. Scalextric and SCX use a standard two-conductor ⅛-inch (3.5 mm) phone jack, so the jacks and plugs can be purchased at an electronics hobby store including Radio Shack. A Carrera, MRRC, or Parma controller can be wired to one of the phone jacks and plugged into a modified Scalextric or SCX connector track.

Carrera and Artin have non-standard plugs and sockets that are not readily available. The plug from a Carrera or Artin controller cable can be cut and attached to a ⅛-inch (3.5 mm) three-conductor phone jack socket to the plug end and a plug to the controller end. You have just made an “adapter” cable that will allow a choice of controllers. The phone jack can be used to connect and disconnect your regular Carrera or Artin controller. You can also use that same adapter cable to plug in a Ninco or Parma controller to the wire connections inside the Parma and Ninco controllers. The color coding is different on the Carrera or Artin controllers than Ninco or Parma. Since there are only three wires, the proper connections can be found by trial and error.

Volts, Amps, and Ohms

With the rapid expansion of home slot racing there are many new hobbyists getting involved who haven't yet acquired an understanding of the basic electrical principles that determine how a slot car runs and responds to control inputs. So . . . here's a little primer that should help with common questions.

The race set's power system plugs into a wall outlet and takes in 110 to 120 volt alternating current (AC). It delivers to the contract rails on the track 12 to 16 volts direct current (DC) on which the cars' motors run. On some sets this conversion takes place entirely in the wallmounted power pack. On others, the “wallwart” contains only the transformer, which lowers the voltage, while the rectifier, which turns AC to DC, is in the terminal track section, most commonly called a connection straight or power base track.

Electrical current is measured in both voltage and amperage. Voltage is sometimes compared to the pressure in a water main, while amperage is analogous to the volume of water passing through the pipe.

The more voltage you feed to a motor the faster its armature will turn until the motor overheats or the centrifugal force of the armature's rotation exceeds its structural capabilities and some part of it flies off. Either way critical parts of the motor self-destruct. When that happens with the motors commonly used in home set slot cars, it's time for a whole new motor. Running a 12-volt motor at 14 or even 16 volts probably won't shorten its life too much. Bumping the power to 24 volts will let the smoke out in rapid order.

Amperage affects performance differently. A motor will only draw as much amperage as it can use. If the power supply is not delivering enough amperage, supplying more will increase motor performance, but only until the motor's needs are satisfied. After that, all the amperages in Grand Coulee Dam won't make the motor run faster. It won't harm it either, but it will increase the probability of catastrophic damage to track and controller wiring in the event of a short circuit.

To drive a slot car you have to vary its speed. The controller does this by introducing resistance, measured in ohms, into the circuit. The controller acts like a valve in a water main, preventing a greater or lesser portion of the available current from reaching the car's motor and thereby changing the car's speed. When the controller trigger is in the off position the circuit is broken completely and no current is flowing. When the trigger is pulled back just a little, the resistor holds back most of the current, converting it to heat, and the car moves slowly. As the trigger is pulled back, more of the current is passed through and the car goes faster. Finally, the wiper button on the trigger makes contact with the full power band on the resistor and all the power reaches the car's motor, just as if it were hard-wired to the power supply.

The biggest single factor determining whether the driver's experience will be fun or frustration is his ability to control the car effectively. To do that, the controller's resistance must match the requirements of the car. If the resistance is too low the car will take off at high speed and reach full throttle before the controller trigger is pulled all the way back. If the resistance is too high the driver may have to pull the trigger as much as halfway back before the car even begins to move. In either case he will have only a portion of the trigger's travel over which to vary the car's speed and it will be much harder for him to drive the car competitively. When controller and car are properly matched the car begins to move slowly as soon as the trigger is pulled even slightly and continues to accelerate until it reaches top speed just as the wiper button reaches the full power band.

Almost all 1:32 scale race sets available today come with controllers that have too much resistance for the cars. Scalextric, SCX, and Ninco sets all have controllers of around 60 to 70 ohms. Non-magnet Ninco cars do fine with such controllers, but most Scalextric cars and the magnet-equipped cars in the Ninco GT and Formula One sets would be happier with 45-ohm controllers. SCX's recent cars, with killer-strong magnets, would be better off with 30-ohm controllers and more power pack amperage as well. All of these manufacturers make lower-ohm controllers (Ninco makes the Vario 16, an effective solid-state controller that can be adjusted to the needs of a wide range of cars) but these optional controllers really should be standard equipment in most sets. Parma controllers, equipped with adapters to plug into the various manufacturers' terminal tracks, are a popular upgrade for many race set owners. Keep in mind, however, that there's a big subjective factor at work here. One driver may be most comfortable driving a particular car with a 60-ohm controller while another may prefer 40 ohms with the same car.

Also, most race set power packs don't really deliver enough amperage to completely supply the needs of two cars. With the set's own cars and others with similar current requirements this isn't too much of a problem, but when the racer starts buying strong-magnet cars, such as the very popular ones made by Fly Car Model of Spain, or puts powerful aftermarket magnets on his race set cars, he finds his cars starved for amperage. Neither achieves full performance when both are running and when one stops or deslots the other gets a blast of power that often sends it off the track. A power system upgrade that feeds each lane separately with its own power supply will meet the requirements of virtually all kind of cars a hobbyist is likely to run on his plastic home track. This can be done using the manufacturer's standard power packs. Scalextric and Ninco both make separate-power-per-line terminal tracks.

Power issues can be some of the most confusing ones confronting newcomers to the hobby and determining the best combination of components for your specific needs may require some expert help, at least until you acquire some experience. We'll be glad to help with advice and information. You can call us toll-free at 1-877-318-7144 or e-mail us at support@fantasyworldhobbies.com. In addition, the following Tech Tips articles will provide more information on power and control systems for your home racing layout and how the cars respond to them:

Matching Controllers to Your Cars

Traction Magnet Basics

Separate Power For Each Lane

Cleaning, Troubleshooting, and Tuning Plastic Sectional Track

Wiring Your Scalextric Track For Dynamic Brakes

Scalextric Power Bases

1. What I claim as my invention is “Lane Power,” an upgraded power source system that feeds each slot car lane separately with its own adjustable regulated power distribution for the Hobby of Slot Cars.
In regard to my invention, “Lane Power,” the purpose for each lane to have its own adjustable regulated direct current power supply is so that each lane is independent of the other lanes. This would allow slot cars to run on their own for model railroading purposes or to be raced against another slot car having different current requirements.
